(19) United States
(12) Patent Application Publication
(10) Pub. No.: US 2017/0067998 A1
(43) Pub. Date: Mar. 9, 2017

(54) TIME SYNCHRONIZATION METHOD BETWEEN SATELLITE AND GROUND EQUIPMENT, AND SATELLITE SYSTEM THEREOF

(71) Applicant: KOREA AEROSPACE RESEARCH INSTITUTE, Daejeon (KR)

(72) Inventor: Yee-jin CHEON, Daejeon (KR)

(73) Assignee: KOREA AEROSPACE RESEARCH INSTITUTE, Daejeon (KR)

(21) Appl. No.: 14/922,990

(22) Filed: Oct. 26, 2015

(30) Foreign Application Priority Data
Sep. 9, 2015 (KR) 10-2015-0127494

(51) Int. Cl. G01S 19/02

(52) U.S. Cl. CPC G01S 19/02

(57) ABSTRACT

A synchronization method between satellite time and ground time, and a satellite system using the same are provided, in which the satellite system includes a satellite and a ground equipment, in which the ground equipment generates a satellite command including information about time difference between the ground time and the satellite time included in a telemetry data frame transmitted from the satellite and transmits the satellite command to the satellite, and the satellite can synchronize the satellite time with the ground time, using the information about the time difference included in the satellite command.

### CROSS-REFERENCE TO RELATED APPLICATIONS

This application claims priority from Korean Patent Application No. 10-2015-0127494, filed on Sep. 9, 2015 in the Korean Intellectual Property Office, the disclosure of which is incorporated herein by reference in its entirety.

### BACKGROUND

1. Field of the Invention

The present disclosure relates to a time synchronization method between satellite and ground equipment, and a satellite system using the same, and more particularly, to a time synchronization method between satellite time and ground time, which is capable of performing time synchronization for a geostationary satellite or a low earth orbit (LEO) satellite for which global positioning system (GPS) receiver can be hardly applied, and a satellite system using the same.

2. Description of the Related Art

Standard time is used for the satellite operation, and the Coordinated Universal Time (UTC) is generally used as the standard time. Meanwhile, the conventional satellite system such as the geostationary satellite system in particular has a problem of gradually increasing difference between the satellite time and the standard time used for the satellite operation over time due to difficulty of adopting GPS receiver, although it requires time synchronization between satellite side and ground side.

FIG. 1 is a diagram provided to explain an operation of a conventional satellite system which does not adopt a GPS receiver.

Referring to FIG. 1, the conventional satellite system may include a satellite 10 and a ground equipment 20.

The ground equipment 20 may include a telemetry frame receiver 21, a satellite command generator 22 and a satellite command transmitter 23.

The telemetry frame receiver 21 may extract the telemetry data frame from a wireless signal downlinked from the satellite 10.

The satellite command generator 22 may generate a satellite command to transmit to the satellite 10.

The satellite command transmitter 23 performs a function of uplinking the satellite command as a wireless signal to the satellite 10.

The satellite 10 includes a command interpreter 11, a processor module time generator 12, a satellite processor module 13, a satellite telemetry manager 14, a telemetry time generator 15, and a satellite telemetry downlinker 16. The command interpreter 11 interprets a satellite command received from the ground equipment 20 and if valid, sends the same to the satellite processor module 13.

The processor module time generator 12 performs a function of providing a clock necessary for the operation of the satellite processor module 13.

The satellite processor module 13 is a part of the computer installed in the satellite 10, and is installed with software to perform operations related with the management of satellite command processing, telemetry management, and so on.

The satellite telemetry manager 14 performs a function of collecting and formatting telemetry data of the satellite 10.

The telemetry time generator 15 performs a function of providing a clock necessary for the satellite telemetry downlinker 16.

The satellite telemetry downlinker 16 performs a function of converting the telemetry data transmitted from the satellite telemetry manager 14 into a wireless signal and sending the same to the ground.

At this time, the satellite time with reference to the processor module time generator 12 or the telemetry time generator 15 is written on the telemetry data and sent to the ground.

As described above, the respective components of the satellite 10 and the ground equipment 20 have to operate with reference to the Coordinated Universal Time (UTC) which is used as a reference time of the satellite operation.

Meanwhile, the clock generator (not illustrated) used in the processor module time generator 12 or the telemetry time generator 15 has an error factor, e.g., initial error, long-term drift and a short-term drift, and over time, the time gap with the processor module time generator 12 or the telemetry time generator 15 increases. Additionally, the clock generator used in the processor module time generator 12 or the telemetry time generator 15 has an increasing time gap from the UTC used as the reference time, due to the error factors mentioned above.

Accordingly, the related technologies suffer time error even within the satellite 10, with the processor module time generator 12 or the telemetry time generator 15, and error with the standard time used for the satellite operation.

As a result, an error can be generated in the satellite orbit information using the satellite operation time information. Further, an error is also generated between execution of the absolute time command and the reference time of the satellite operation, and a large ground location error is also generated due to a difference between the telemetry data acquired from the satellite or the task data written in the task data, and the reference time of the satellite operation.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to an embodiment, a technical objective is to provide a time synchronization method between satellite time and ground time, which can perform time synchronization between satellite and the ground, for a geostationary satellite or low earth orbit satellite to which a GPS receiver can be hardly adopted, and a satellite system using the same.

In order to achieve the objects mentioned above, according to an embodiment, provided is a satellite system which may include a satellite and a ground equipment for operating the satellite from the ground, in which the ground equipment may generate a satellite command including information about time difference between a ground time and a satellite time included in a telemetry data frame transmitted from the satellite, and transmits the generated satellite command, and the satellite may synchronize the satellite time with the ground time, using the information about the time difference contained in the satellite command.

The ground equipment may include a telemetry frame synchronizer which obtains the time difference between the ground time and the satellite time included in the telemetry data frame transmitted from the satellite, a satellite command generator which generates the satellite command comprising the information about the time difference, and a command transmitter which transmits the satellite command comprising the time difference information corresponding to the time difference to the satellite.

The satellite may include a command interpreter which interprets the satellite command received from the ground equipment and acquires the time difference information, a time difference counter register which stores a time difference counter value of counting the time difference information, and a satellite reference time generator which generates a time sync signal according to a reference number of pulses which is increased or decreased based on the time difference counter value stored in the time difference counter register.

The satellite may additionally include a satellite telemetry downlinker which starts transmitting the telemetry data frame to the ground equipment at a time point when the time sync signal is generated.

The satellite may include a satellite time manager to synchronize the satellite time with the ground time based on the time difference information.

The satellite may include a satellite time manager which increases or decreases the satellite time by a reference time at a time point when a value obtained as a result of multiplying an error per reference time by an accumulated time exceeds the reference time, and sets the time difference between the satellite time and the ground time to ‘0’.

The error per reference time may be calculated by using an error between the satellite time and the ground time for a predetermined period of time, and the accumulated time may be accumulated from a time point when the time difference between the satellite time and the ground time is set to ‘0’. In order to achieve the objects mentioned above, according to an embodiment, a synchronization method of satellite time and ground time is provided, which may include obtaining, at a ground equipment, information about a time difference between a ground time and a satellite time included in a telemetry data frame transmitted from a satellite, generating, at the ground equipment, a satellite command comprising the information about the time difference and transmitting the satellite command to the satellite, and synchronizing, at the satellite, the satellite time with the ground time, using the information about the time difference included in the satellite command.

The synchronizing, at the satellite, the satellite time with the ground time may include interpreting the satellite command received from the ground equipment so as to acquire the time difference information, storing a time difference counter value of counting the time difference information at a time difference counter register, and generating a time sync signal according to a reference number of pulses which is increased or decreased based on the time difference counter value stored at the time difference counter register.

The synchronization method may additionally include starting transmitting a telemetry data frame from the satellite to the ground equipment at a time point when the time sync signal is generated.

The synchronizing, at the satellite, the satellite time with the ground time may include setting the time difference between the satellite time and the ground time to ‘0’, determining if the time difference obtained as a result of multiplying the error per reference time by the accumulated time exceeds a reference time, and increasing or decreasing the satellite time by the reference time at a time point when the accumulated time error exceeds the reference time.

According to exemplary embodiments of the present disclosure, time synchronization can be performed at low cost between satellite and the ground, for satellite such as a geostationary satellite or a low earth orbit (LEO) satellite which can hardly adopt a GPS receiver. Further, a satellite installed with a GPS receiver may use the present disclosure as a backup (or replacement) system in case the GPS receiver is out of order. Further, time difference between the satellite time and the Coordinated Universal Time (UTC), used as a reference for the satellite operation, can be calculated easily.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a diagram provided to explain an operation of a conventional satellite system which does not adopt a GPS receiver;

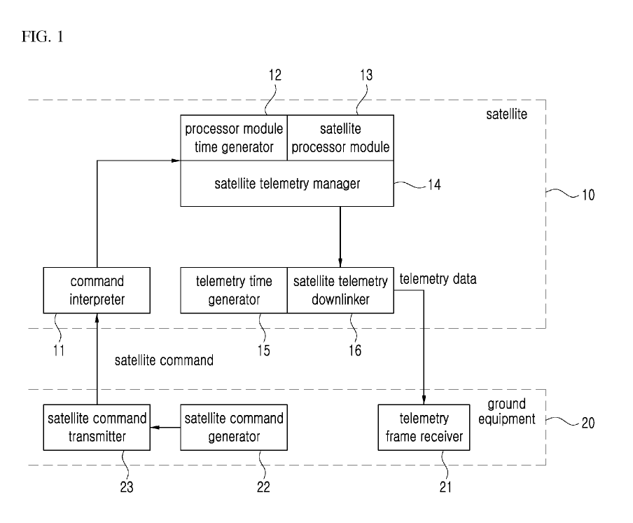

FIG. 2 is a block diagram of a satellite system according to an exemplary embodiment;

FIG. 3 is a diagram exemplifying a telemetry data frame format according to an exemplary embodiment;

FIG. 4 is a flowchart provided to explain a synchronization operation between satellite time of a satellite system and a ground time, according to an exemplary embodiment;

FIG. 5 is a flowchart provided to explain in detail an operation of a satellite according to an exemplary embodiment; and

FIG. 6 is a flowchart provided to explain an operation of adjusting autonomous time difference of a satellite according to an exemplary embodiment.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

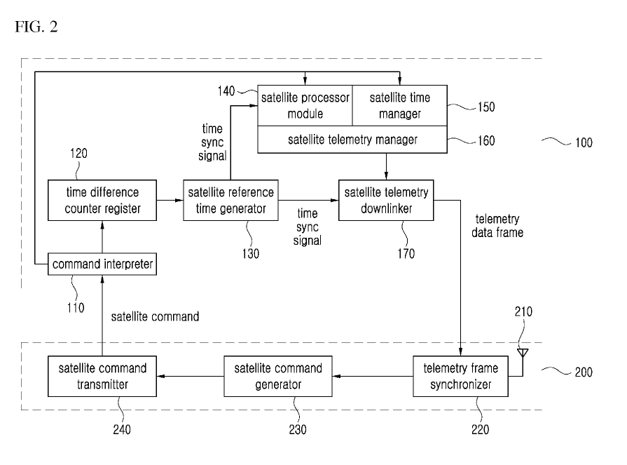

FIG. 2 is a block diagram of a satellite system according to an exemplary embodiment.

Referring to FIG. 2, the satellite system according to an exemplary embodiment may include a satellite 100 and a ground equipment 200.

The ground equipment 200 may perform a function of operating the satellite 100 from the ground, and may include a GPS receiver 210, a telemetry frame synchronizer 220, a satellite command generator 230, and a satellite command transmitter 240.

The GPS receiver 210 performs a function of receiving a GPS signal from a GPS satellite (not illustrated), and depending on embodiments, the GPS receiver 210 may be implemented separately, instead of being included in the ground equipment 200.

The telemetry frame synchronizer 220 may operate to extract a satellite time included in a telemetry data frame transmitted from the satellite 100 and calculate a time difference between the satellite time and the ground time.

The Coordinated Universal Time (UTC) may be used as a reference time for operating the satellite. The ground equipment 200 may calculate a UTC from the GPS signal received through the GPS receiver 210 and utilize the same as the ground time. On the contrary, although being set to the UTC at initial launch, the satellite time gradually develops an error with the ground time (UTC) since the satellite 100 is launched into the space without a GPS receiver.

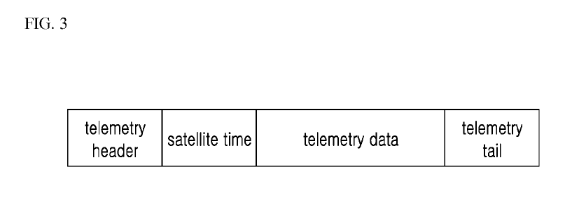

FIG. 3 is a diagram exemplifying a telemetry data frame format according to an exemplary embodiment.

Referring to FIG. 3, the telemetry data frame format may include a telemetry header, a satellite time, a telemetry data, and a telemetry tail. The “satellite time” as used herein may refer to time at which the satellite 100 generates a telemetry data frame. In this case, for calculation of satellite/ground time difference, it is necessary to take into consideration a difference between the time at which the satellite 100 generates a telemetry data frame and the time at which the telemetry data frame is started to be transmitted to the ground equipment 200. Depending on exemplary embodiments, the satellite time of the telemetry data frame may be set to the time of starting transmission of the telemetry data frame to the ground equipment 200.

Referring again to FIG. 2, the telemetry frame synchronizer 220 may obtain the time difference between the satellite time and the ground time using mathematical equation 1 as follows:

T_{UTC}=T_{SAT}+ΔT+T_{R}+T_{D} [Mathematical Equation 1]

where, T_{UTC} is a ground time corresponding to the telemetry frame synchronization UTC, T_{SAT} is a satellite time included in the telemetry data, ΔT is a time difference between satellite time and ground time, T_{R} is a time of arrival between satellite and the ground, and T_{D} is a telemetry frame measurement delay time.

T_{R} may be calculated by the time of dividing the distance between the satellite 100 and the ground by the speed of light. T_{D} may be calculated by the internal processing time delay at the telemetry frame synchronizer 220, but the value may be neglected depending on embodiments, as the value is too small to give influence.

The time difference ΔT between the satellite time and the ground time may be obtained by ‘T_{UTC}−T_{SAT}−T_{R}−T_{D}’. The time difference between the satellite time and the ground time will be referred to as “satellite/ground time difference” below.

The satellite command generator 230 generates a satellite command to be transmitted from the ground equipment 200 to the satellite 100. Specifically, the satellite command generator 230 may generate a satellite command which includes information about the satellite/ground time difference as obtained at the telemetry frame synchronizer 220. The satellite command including the satellite/ground time difference may be generated at a predetermined period (e.g., 1 hour, 1 day, etc.) or generated with the current ground time included therein as requested by an operator of the ground equipment 200.

The satellite command transmitter 240 performs a function of uplinking the satellite command generated at the satellite command generator 230 to the satellite 100.

The satellite 100 interprets a satellite command unlinked from the ground equipment 200 and performs a corresponding operation. When the satellite command unlinked from the ground equipment 200 includes information about the satellite/ground time difference, the satellite 100 may accordingly perform an operation for synchronization between the satellite time and the ground time.

The satellite 100 may include a command interpreter 110, a time difference counter register 120, a satellite reference time generator 130, a satellite processor module 140, a satellite time manager 150, a satellite telemetry manager 160, and a satellite telemetry downlinker 170.

The command interpreter 110 interprets a satellite command received from the ground equipment 200 and when valid, performs a function of transmitting it to the satellite processor module 140. Further, when the satellite command includes information about satellite/ground time difference, the command interpreter 110 may transmit the same to the time difference counter register 120.

The satellite reference time generator 130 may generate a time sync signal for use in operating a device installed in the satellite 100 based on the time difference counter value stored in the time difference counter register 120.

The satellite reference time generator 130 may include an oscillator and be implemented so as to count a number of pulses generated from the oscillator and generate a time sync signal whenever the reference number of pulses is met. The reference number of pulses for generating the time sync signal may be increased or decreased according to the time difference counter value as stored in the time difference counter register 120. For example, when the time difference counter value is 2 in an initial setting according to which a time sync signal is generated each time 100 pulses are generated (e.g., when reference number of pulses is 100), the reference number of pulses may be increased to 102. Accordingly, it may be implemented such that the time sync signal is generated each time 102 pulses are generated. As described above, the time difference between the satellite time and the ground time may be reduced by increasing or decreasing the reference number of pulses for generating the time sync signal according to the time difference counter value. For example, when the satellite time is lagging behind the ground time, the time difference counter value may be reduced. On the contrary, when the satellite time is leading ahead of the ground time, the time difference counter value may be increased.

The time difference counter register 120 may receive the information about the satellite/ground time difference from the command interpreter 110. The time difference counter register 120 counts a newly transmitted satellite/ground time difference with the previously stored time difference counter value, and stores the counted value as a new time difference counter value.

For example, it is assumed herein that, in order to compensate for the 7 μsec/sec lagging of the satellite time behind the ground time, the time difference counter register 120 is operating with the time difference counter value stored as −7. In such state, in response to transmission of the time difference information corresponding to the satellite time being faster than the ground time by 2 μsec/sec, the time difference counter register 120 may change the time difference counter value to −5, which is obtained by adding 2 to −7, and store the same. Note that the time difference counter value is not limited to the example provided above, and accordingly, can be implemented according to various embodiments.

The satellite processor module 140 is a part of a computer installed in the satellite 100 and includes software installed therein to perform operations related with satellite command processing, telemetry management, and so on. The satellite processor module 140 may operate according to a time sync signal provided from the satellite reference time generator 130.

The satellite telemetry manager 160 performs telemetry data collection and formatting at the satellite 100.

The satellite telemetry downlinker 170 performs a function of encoding or encrypting the telemetry data transmitted from the satellite telemetry manager 160, converting the same into a wireless signal and transmitting the result to the ground.

The satellite telemetry downlinker 170 may be implemented so as to start transmission of the telemetry data frame to the ground equipment 200 at a time point when the time sync signal is generated. Accordingly, the time difference between the satellite time and the ground time can be calculated with increased ease and accuracy.

The satellite time manager 150 performs a function of managing the satellite time of the satellite 100 in a software manner. Specifically, the satellite time manager 150 may receive the information about the satellite/ground time difference contained in the satellite command from the command interpreter 110 and converting the satellite time in synchronization with the ground time. Of course, it is not necessary to separately perform the operation of synchronizing the satellite time with the ground time, when adjustment is made in hardware level by increasing or decreasing the reference number of pulses for generating time sync signal at the satellite reference time generator 130.

The satellite time manager 150 may perform an autonomous time difference adjustment function of the satellite 100. More specifically, the reference time may be added to the satellite time at a time point when the value (i.e., time difference) obtained as a result of multiplying the error per reference time by accumulated time is increased to exceed the reference time, after which the time difference between the satellite time and the ground time may be reset to ‘0’.

The “error per reference time” as used herein represents an error generated at the satellite time and the ground time for a predetermined period of time. For example, when the reference time is 1 second, the error per reference time refers to the time error generated between the satellite time and the ground time with reference to 1 second. That is, when the satellite time is lagging behind the ground time for 5 μsec per 100 msec, the error per reference time is 50 μsec. Then when the accumulated time exceeds 20,000 sec (that is, 5 hour, 33 minutes, and 20 seconds), the total accumulated time difference exceeds 1 sec. The satellite time manager 150 may then synchronize the satellite time with the ground time by increasing the satellite time by 1 sec. The time difference between the satellite time and the ground time may then be set back to ‘0’ sec.

As exemplified above, the reference time may be set to 1 second, but not limited thereto. Accordingly, the reference time may be set to 1 minute, 1 hour, 1 day, or various others depending on embodiments. Further, the error per reference time may be included in advance in the satellite command at the ground equipment 200 and transmitted to the satellite 100.

Meanwhile, when the satellite time is leading ahead of the ground time, conversely, the reference time may be subtracted from the satellite time. For example, when the accumulated time error is −1 sec, 1 sec may be subtracted from the satellite time for synchronization with the ground time.

Meanwhile, the satellite 100 may perform synchronization between the satellite time and the ground time, when the satellite 100 cannot receive a satellite command from the ground equipment 200 because the satellite 100 performs autonomous time difference adjusting function with the previously-transmitted error per reference time. Of course, the error per reference time may be obtained at the satellite 100 according to some embodiments. The error per reference time may also be calculated at the satellite 100, using the information about satellite/ground time difference which is included in the satellite command and transmitted.

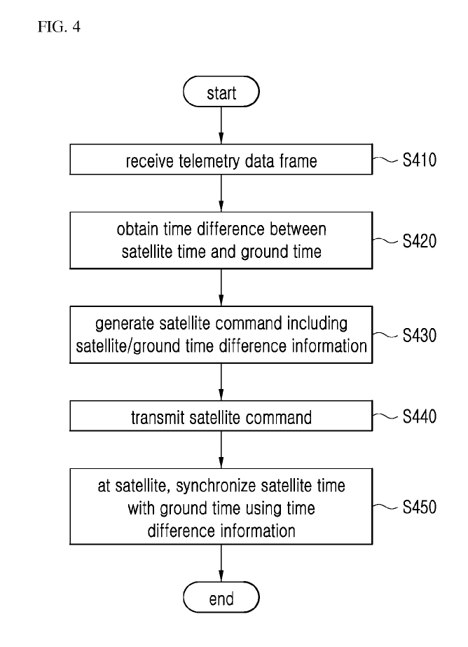

The synchronization method between the satellite time and the ground time of the satellite system according to exemplary embodiments of the present disclosure will be explained below with reference to FIGS. 4 to 6.

FIG. 4 is a flowchart provided to explain a synchronization operation between satellite time of a satellite system and a ground time, according to an exemplary embodiment.

Referring to FIG. 4, first, at S410, the ground equipment 200 may receive a telemetry data frame downlinked from the satellite 100, and at S420, calculate at the telemetry frame synchronizer 220 the satellite/ground time difference by extracting the satellite time included in the telemetry data frame. The “ground time” as used herein may be the reference time for operating the satellite, and the UTC may be used. The GPS receiver 210 may receive a GPS signal and calculate the UTC.

Next, at S430, the satellite command generator 230 may generate a satellite command including information about satellite/ground time difference obtained at the telemetry frame synchronizer 220. The satellite command including the satellite/ground time difference may be generated at a predetermined period (e.g., 1 hour, 1 day, etc.), or generated with the current ground time included therein as requested by an operator of the ground equipment 200.

The satellite command transmitter 240 may then uplink the satellite command generated at the satellite command generator 230 to the satellite 100, at S440.

At 5450, when the satellite command unlinked from the ground equipment 200 includes information about satellite/ground time difference, the satellite 100 may perform an operation for synchronization between the satellite time and the ground time, using the information about the satellite/ground time difference.

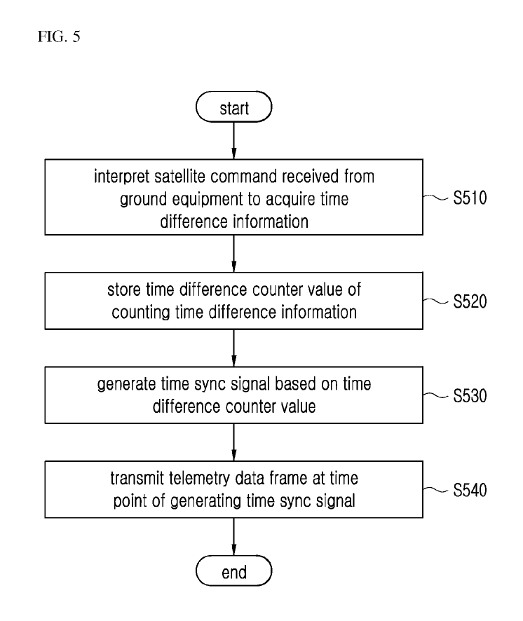

Next, the operation of the satellite 100 performing time synchronization between satellite time and ground time, using the information about the satellite/ground time difference included in the satellite command, will be explained detail below with reference to FIG. 5.

FIG. 5 is a flowchart provided to explain in detail an operation of a satellite according to an exemplary embodiment.

Referring to FIG. 5, at S510, when the satellite 100 receives a satellite command uplinked from the ground equipment 200, the command interpreter 110 may interpret the received satellite command, acquire the information about the satellite/ground time difference and transmit the same to the time difference counter register 120.

Next, at S520, the time difference counter register 120 counts the newly transmitted satellite/ground time difference from the command interpreter 110 with the previously stored time difference counter value, and stores the counted value as a new time difference counter value.

The satellite reference time generator 130 then increases or decreases the reference number of pulses according to the time difference counter value stored at the time difference counter register 120, and generates a time sync signal accordingly, at S530.

Meanwhile, the satellite telemetry downlinker 170 may be implemented so as to begin transmission of the telemetry data frame to the ground equipment 200 at a time point when the time sync signal is generated, at S540. As a result, the time difference between the satellite time and the ground time can be calculated with increased ease and accuracy.

The ground equipment 200 may obtain the satellite/ground time difference and perform operations at S410 to S440 as exemplified in FIG. 4, using the satellite time included in the satellite telemetry data frame transmitted at S540.

Depending on embodiments, the satellite time manager 150 may receive the information about the satellite/ground time difference included in the satellite command from the command interpreter 110 and software-wise perform the satellite time synchronization, in which case the operations at S520 to S530 may be skipped.

Further, the satellite time manager 150 may perform autonomous time difference adjusting function of the satellite 100.

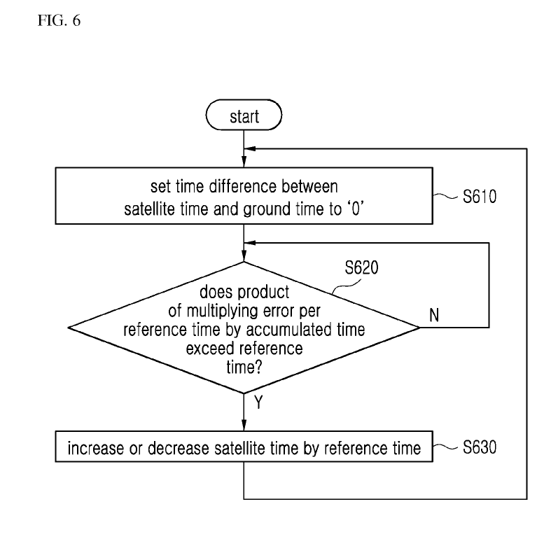

FIG. 6 is a flowchart provided to explain an operation of adjusting autonomous time difference of a satellite according to an exemplary embodiment.

Referring to FIG. 6, first, at S510, the satellite time manager 150 sets the time difference between the satellite time and the ground time to ‘0’.

Next, at S520, the satellite time manager 150 repeats an operation of determining if the value (i.e., time difference) obtained by multiplying an error per reference time by the accumulated time exceeds the reference time.

At S520—Y, when the result of determination indicates that the time difference exceeds the reference time, at S530, the satellite time manager 150 may add the reference time to the satellite time at a time point when the time difference exceeds the reference time. When the error per reference time at S530 corresponds to a situation in which the satellite time is lagging behind the ground time, the satellite time is increased by the reference time. On the contrary, when the error per reference time at S530 corresponds to a situation in which the satellite time is leading ahead of the ground time, the satellite time is increased by the reference time.

The satellite time manager 150 may prevent the time difference between the satellite time and the ground time from increasing above the reference time, by repeatedly performing the operations at S510 to S530.

An exemplary embodiment includes a computer-readable recording medium including a program command to execute an operation to be implemented on a variety of computers. The recording medium records a program to execute a time synchronization method between satellite time and ground time, as described above. The recording medium may include a program command, a data file, and data structure, and so on, either alone or in combination. An example of the recording medium includes a magnetic medium such as a hard disk, a floppy disk and a magnetic tape, an optical recording medium such as a CD and a DVD, and a hardware device configured to store a program command and execute the same, such as a floptical disk and a magneto-optical disk, a ROM, a RAM, a flash memory, and so on. An example of the program command includes not only machine code made by a compiler, but also high level language code executable by a computer using an interpreter, or the like.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

What is claimed is:

1. A satellite system comprising a satellite and a ground equipment for operating the satellite from a ground, wherein
the ground equipment generates a satellite command comprising information about a time difference between a ground time and a satellite time included in a telemetry data frame transmitted from the satellite and transmits the satellite command to the satellite, and
the satellite synchronizes the satellite time with the ground time, using the information about the time difference included in the satellite command.

2. The satellite system of claim 1, wherein the ground equipment comprises:
a telemetry frame synchronizer which obtains the time difference between the ground time and the satellite time included in the telemetry data frame transmitted from the satellite;
a satellite command generator which generates the satellite command comprising the information about the time difference; and
a command transmitter which transmits the satellite command comprising the time difference information corresponding to the time difference to the satellite.

3. The satellite system of claim 1, wherein the satellite comprises:
a command interpreter which interprets the satellite command received from the ground equipment and acquires the time difference information;
a time difference counter register which stores a time difference counter value of counting the time difference information; and
a satellite reference time generator which generates a time sync signal according to a reference number of pulses which is increased or decreased based on the time difference counter value stored in the time difference counter register.

4. The satellite system of claim 3, wherein the satellite further comprises a satellite telemetry downlinker which starts transmitting the telemetry data frame to the ground equipment at a time point when the time sync signal is generated.

5. The satellite system of claim 1, comprising:
a command interpreter which interprets the satellite command transmitted from the ground equipment and acquires the time difference information; and
a satellite time manager which synchronizes the satellite time with the ground time based on the time difference information.

6. The satellite system of claim 1, wherein the satellite comprises a satellite time manager which increases or decreases the satellite time by a reference time at a time point when a value obtained as a result of multiplying an error per reference time by an accumulated time exceeds the reference time, and sets the time difference between the satellite time and the ground time to ‘0’, wherein
the error per reference time is calculated by using an error between the satellite time and the ground time for a predetermined period of time, and the accumulated time is accumulated from a time point when the time difference between the satellite time and the ground time is set to ‘0’.

7. A satellite, comprising:
a command interpreter which interprets a satellite command transmitted from a ground equipment operating the satellite so as to acquire information about time difference between a satellite time and a ground time included in the satellite command;
a time difference counter register which stores a time difference counter value of counting the time difference information; and
a satellite reference time generator which generates a time sync signal according to a reference number of pulses which is increased or decreased based on the time difference counter value stored in the time difference counter register.

8. The satellite of claim 7, further comprising a satellite telemetry downlinker which starts transmitting a telemetry data frame to the ground equipment at a time point when the time sync signal is generated.

9. The satellite of claim 7, further comprising a satellite time manager which increases or decreases the satellite time by a reference time at a time point when a value obtained as a result of multiplying an error per reference time by an accumulated time exceeds the reference time, and sets the time difference between the satellite time and the ground time to ‘0’, wherein
the error per reference time is calculated by using an error between the satellite time and the ground time for a predetermined period of time, and the accumulated time is accumulated from a time point when the time difference between the satellite time and the ground time is set to ‘0’.

10. A synchronization method of satellite time and ground time, comprising:
obtaining, at a ground equipment, information about a time difference between a ground time and a satellite time included in a telemetry data frame transmitted from a satellite;
generating, at the ground equipment, a satellite command comprising the information about the time difference and transmitting the satellite command to the satellite; and
synchronizing, at the satellite, the satellite time with the ground time, using the information about the time difference included in the satellite command.

11. The synchronization method of claim 10, wherein the synchronizing, at the satellite, the satellite time with the ground time comprises:
interpreting the satellite command received from the ground equipment so as to acquire the time difference information;
storing a time difference counter value of counting the time difference information at a time difference counter register; and
generating a time sync signal according to a reference number of pulses which is increased or decreased based on the time difference counter value stored at the time difference counter register.

12. The synchronization method of claim 10, further comprising starting transmitting a telemetry data frame from the satellite to the ground equipment at a time point when the time sync signal is generated.

13. The synchronization method of claim 10, wherein the synchronizing, at the satellite, the satellite time with the ground time comprises:
setting the time difference between the satellite time and the ground time to ‘0’;
determining if the time difference obtained as a result of multiplying the error per reference time by the accumulated time exceeds a reference time; and
increasing or decreasing the satellite time by the reference time at a time point when the accumulated time error exceeds the reference time, wherein
the error per reference time is calculated by using an error between the satellite time and the ground time for a predetermined period of time, and the accumulated time is accumulated from a time point when the time difference between the satellite time and the ground time is set to ‘0’.
